(19) United States
(12) Patent Application Publication
(10) Pub. No.: US 2001/0039997 A1
(43) Pub. Date: Nov. 15, 2001

(54) PROCESS AND DEVICE FOR PRODUCING A CONTINUOUS TUBULAR FILM FROM A FLAT FILM WEB

(76) Inventor: ROLAND ZEUSCHNER, ARGENBUEHL-SIGGEN (DE)

Correspondence Address: WHYTE HIRSCHBOECK DUDEK S C, 111 EAST WISCONSIN AVENUE, SUITE 2100, MILWAUKEE, WI, 53202

(21) Appl. No.: 09/244,260

(22) Filed: Feb. 3, 1999

(30) Foreign Application Priority Data
Feb. 4, 1998 (DE) 19804221.3

(51) Int. Cl. B29C 53/00; B32B 31/00

(52) U.S. Cl. 156/203; 156/275.1; 156/497

(57) ABSTRACT

A process and device are described for producing a continuous tubular film from a flat film web which is shaped by a shaping arrangement into a tubular film that is open on the longitudinal side with overlapping edges, the tubular film being continuously supplied to a sealing arrangement which welds the overlapping edges of the film on the longitudinal side to one another. The invention is distinguished by the fact that welding of the edges of the film in the sealing arrangement is effected by the application of hot air.

### BACKGROUND OF THE INVENTION

1. Field of the Invention

This invention relates to a process and to a device for producing a continuous tubular film from a flat film web, in accordance with the preamble to the independent claims, which is incorporated herein by reference.

2. Description of Related Art

A device of this type and a process for producing a tubular film is known from DE 38 41 056 A1, for example. In this case a flat film is shaped by a shaping arrangement into a tubular film that is open on the longitudinal side with overlapping edges, the tubular film subsequently being continuously supplied to a sealing station which welds the overlapping edges of the film to one another. This sealing station consists of a heating element in the form of a sealing bar which welds the overlapping edges of the tubular film under pressure. A disadvantage with this process is that wear occurs on the film and on the sealing bar as a result of the constant contact of the film with the sealing bar, a weakening of the film being caused in the region of the sealed seam by the notch effect of the sealing bar. Furthermore, the speed of sealing and of the continuously moving film web in the upward direction is limited, in order to achieve flawless sealing and to prevent damage to the continuously moving tubular film.

The object underlying the invention is therefore to propose a process and a device for producing a continuous tubular film, said process operating in wear-free manner, permitting a high throughput speed of the film and preventing weakening of the film or damage thereto.

### SUMMARY OF THE INVENTION

This object is achieved by virtue of the characterizing features of the independent claims, which are incorporated herein by reference.

### BRIEF DESCRIPTION OF THE DRAWINGS

FIG. 1 shows a lateral section through one embodiment of a device for producing a tubular film;

FIG. 2 shows a front view of the sealing arrangement, viewed in the direction towards the outlet nozzles.

FIG. 3 shows an enlarged view of the sealing arrangement and the tubular film wrapped around a substantially rigid form having a region of overlap.

### DETAILED DESCRIPTION OF THE INVENTION

An important feature of the present invention is that welding of the overlapping film is effected by contact with hot air. In a preferred embodiment, welding of the overlapping film is effected without mechanical contact with a solid heating element, and even more preferably without any mechanical contact with the outer surface of overlapping film. In an even more preferred embodiment, welding to the overlapping film is effected in a contact-free manner (other than the contact with the hot air). The hot air is preferably at a temperature equal to or greater than the sealing temperature of the film. When the film is a multilayer film, the temperature is preferably equal to or greater than the sealing temperature of an exposed layer (as opposed to a sandwiched layer) having the lowest softening temperature.

Further developments and advantageous configurations of the invention are subjects of the dependent claims, which are incorporated herein by reference.

For instance, provision is made for the hot air for welding the film to be generated from compressed air, preferably ordinary compressed air, which is heated up by suitable heating arrangements to a temperature equal to or greater than the sealing temperature of the film. In one embodiment, the temperature is in the range from about 150° to about 190° C., more preferably about 170° Celsius. The hot air is preferably supplied to the tubular film via nozzles. At the same time, the temperature and/or the amount of hot air supplied is preferably regulated. In a more preferred embodiment, the temperature and/or the amount of hot air supplied is capable of being adapted rapidly to the requisite conditions.

The temperature of the hot air in the outlet channel is preferably measured by a temperature sensor and, in response to the measured temperature, the heat output of the heating arrangement is regulated.

In one embodiment, the sealing arrangement preferably comprises a casing with at least one air inlet for accepting the compressed air, the compressed air within the casing preferably branching in a number of distribution channels and the air then being supplied from the distribution channels via overflow channels to at least one heating arrangement. The air which is heated up there is in turn preferably supplied via overflow channels to the outlet channel and applied to the tubular film via one or more outlets.

In another embodiment, the air is heated up prior to compressing the air, and then the heated compressed air is applied to the tubular film via one or more outlets as in the other embodiment. In this embodiment, the sealing arrangement comprises the one or more outlets for applying the compressed hot air to the tubular film.

The sealing arrangement generally comprises one or more, preferably a plurality of, outlets for the hot air directed toward the area of film overlap, and in a preferred embodiment the outlets are one or more outlet nozzles, preferably a plurality of outlet nozzles. The one or more outlets are preferably arranged at a selected distance from the tubular film, so that they do not come in contact with the latter while the latter is passing by the same. In one embodiment, the selected distance is preferably at least about 0.01 mm and in another embodiment is preferably less than 5 mm, more preferably less than 0.5 mm.

The heating arrangement preferably comprises an electrically operated heating cartridge comprising heating coils which the inflowing air flows around, so that the relatively cold air is heated up via the electrically operated heating coils.

The tubular film is preferably wrapped around, and preferably in loose-fitting contact with, a shaping tube while the hot air is applied to the tubular film. In this embodiment, the one or more outlets of the sealing arrangement are preferably located adjacent, and proximate, to the region of overlap of the tubular film at the side of the tubular film opposite to the side of the tubular film which is in loose-fitting contact with the shaping tube. The shaping tube preferably has an elongated shape and has a cross-section substantially circular or oval in shape. The shaping tube preferably has one end extending below the sealing arrangement.

A significant advantage of sealing with hot air is that thinner films can be used to produce the tubular film, since the sealing process may be carried out without mechanical contact between the film and the sealing arrangement. In one preferred embodiment, the process of this invention is carried out with a film having a thickness of about 0.5 mm or less, more preferably about 0.1 mm or less, and even more preferably about 0.06 mm or less. This results in a significant cost saving in terms of film material.

A further advantage is that welding according to the preferred embodiment is carried out in a manner that is virtually wear-free for the sealing arrangement, since the sealing arrangement does not come into mechanical contact with the tubular film.

Furthermore, the heat output of the sealing arrangement can be adapted rapidly to changing conditions such as, for example, changes in the thickness of the film, etc. Various parameters of the sealing arrangement—such as, for example, temperature, pressure of the inflowing relatively cold compressed air and flow volume of the compressed air - can be adjusted within wide ranges. However, control of heat output is preferably effected merely by varying the pressure or the volume of flow, the temperature of the air remaining constant (for example, being kept approximately constant at 170° Celsius).

A further advantage of this arrangement is that a narrower film web can be employed in order to obtain tubular films having the same diameter as in the state of the art (in which working takes place with sealing bars). This is possible, since there is preferably no contact welding here but welding can take place in contact-free manner (i.e., without mechanical contact between a heating element and the tubular film) and substantially at a precise point. In addition, no weakening of the film to be welded occurs in the region of the welded seam using the preferred embodiments of this invention, since no sealing bars are employed which cause a notch effect at the welded seam. As a result of the preferred contact-free welding, the speed of the continuously moving tubular film can also be increased.

The invention is elucidated in more detail below with reference to figures of the drawing on the basis of an embodiment example shown in the drawings.

As shown in FIG. 1, the flat film web 1, which preferably consists of plastic, is unwound from a spool (not shown) and arrives continuously at a shaping arrangement consisting of a shaping shoulder, by means of which the flat film web is shaped into a tubular film 3 that is open on the longitudinal side with overlapping portions adjacent to the edges, and is transported further in the direction of transport 25 on a cylindrical shaping tube 4. The shaping shoulder 2 and the shaping tube 4 are retained in a holder 5.

The shaping tube 4 extends further in the direction of transport 25 into the region of the sealing arrangement 9 which is secured to the machine casing on a mounting 6. The mounting 6 is supported in a swivel bearing 7 so as to be rotatable about a vertical axis, it being possible for the mounting 6 to be arrested by an attachment screw 11 which is part of a swivel arm 10 secured to the holder 5. Hence the mounting 6 is firmly connected to the holder 5 in order to prevent unintentional swivelling.

The casing 14 of the preferred sealing arrangement is connected to the mounting 6 via an attachment arm 8. Various adjusting devices are provided, in order to be able to undertake an alignment of the casing 14 in relation to the shaping tube 4. A stop adjustment 12 is present which is supported on the machine casing and by means of which the distance of the casing 14 of the sealing arrangement from the shaping tube 4 can be adjusted. Furthermore, an inclination-adjusting mechanism 13 is provided, by means of which the inclination of the casing 14 in relation to the axis of the shaping tube 4 can be adjusted. As a result, a uniform distance between the casing 14 of the sealing arrangement and the shaping tube 4 can be adjusted over the length of the shaping tube.

The casing 14 of the sealing arrangement 9 comprises at least one air inlet 15, the incoming compressed air being distributed within the casing 14 by means of distribution channels 16 branching in tree-like manner and being supplied to the heating arrangement in spatially distributed manner via overflow channels 19 (for bringing the compressed air in contact with heating arrangement). The heating arrangement preferably comprises a first heating cartridge 17 which is preferably adjoined by a second heating cartridge 18. The heating cartridges 17, 18 are preferably of approximately tubular construction and possess a heating coil which heats the compressed air flowing into the inner volume of the heating cartridge. The heated hot air leaves the heating cartridge 18 via overflow channels 20 and arrives at an outlet channel 21 which is arranged in the longitudinal direction parallel to the shaping tube 4. The heating coil is preferably electrical (i.e., capable of generating heat when connected to a source of electric current).

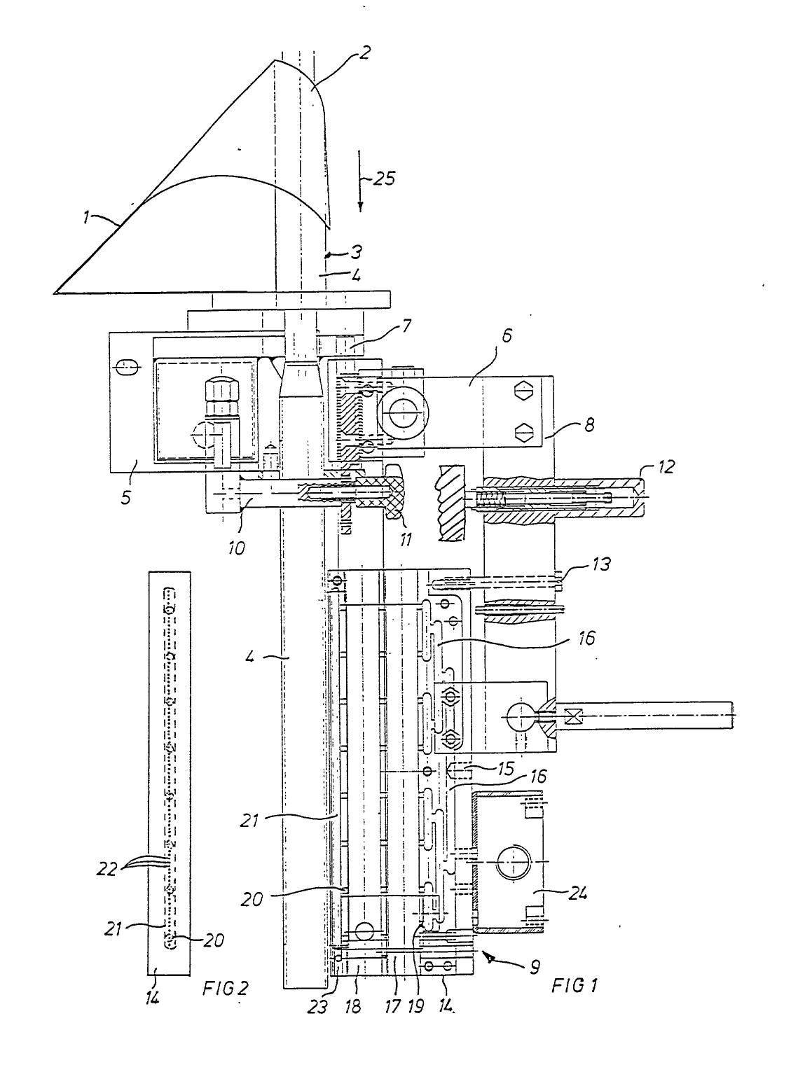

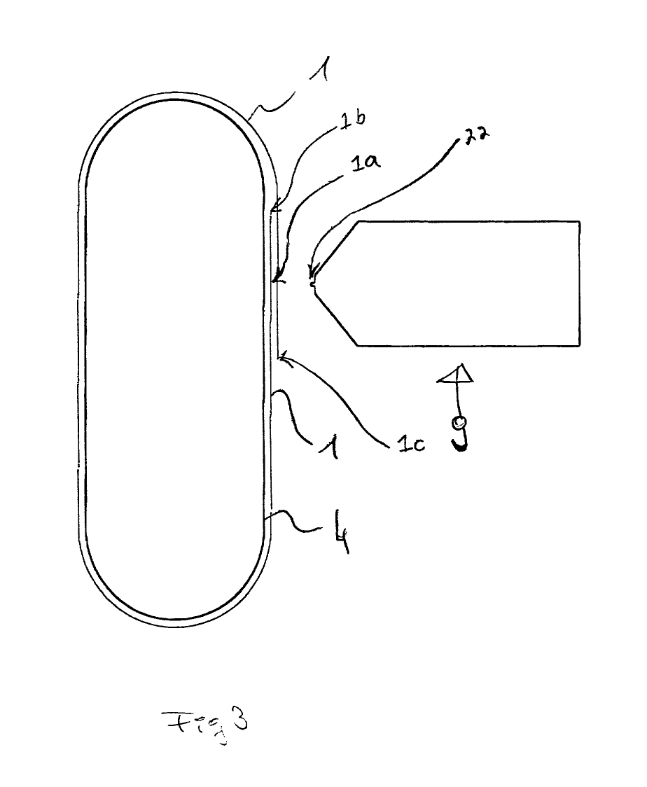

As represented in FIG. 2, the outlet channel 21 possesses on the side facing the shaping tube 4 a plurality of outlet nozzles 22, through which the hot air emerges and impinges on the tubular film 3 which is guided along the shaping tube 4. At the same time the tubular film 3 is aligned on the shaping tube 4 in such a way that the overlapping portion of the film (between the longitudinal edges of the film) come to be situated opposite the outlet nozzles 22 and are continuously welded to one another by the emerging hot air. In this preferred embodiment, the sealing arrangement 9 does not touch the surface of the tubular film, so that welding takes place in contact-free manner (free of mechanical contact with a solid heating element).

In the region of the outlet channel 21, a temperature sensor 23 is arranged, by means of which the temperature of the hot air in the outlet channel 21 is measured. Depending on the measured temperature, the heat output of the heating cartridges 17, 18 is regulated, and in this way a constant temperature of the hot air corresponding to the preset value is achieved.

The requisite electrical equipment and electronics for this embodiment of the sealing arrangement are advantageously located in a separate casing 24, facilitating access to and maintenance of the electrical equipment.

FIG. 3 shows an enlarged view, not to scale, of the preferred relationship between the sealing arrangement 9 and the tubular film 1. Outlet nozzle(s) 22 are directed toward the overlapping portion 1a of the tubular film 1. The overlapping portion is located between first edge 1b and second edge 1c of the tubular film 1. The tubular film 1 is formed around shaping tube 4. Hot air emitted from the outlet nozzle(s) 22 of sealing arrangement 9 weld together the overlapping portion 1a of the tubular film 1 to form a tube capable of retaining a product introduced into the tubular film 1 after passing by the sealing arrangement.

### Drawing Legend

1 film web

2 shaping shoulder

3 tubular film (open)

4 shaping tube

5 holder (for shaping shoulder and shaping tube)

6 mounting (for sealing arrangement)

7 swivel bearing

8 attachment arm

9 sealing arrangement

10 swivel arm (on holder)

11 attachment screw

12 stop adjustment

13 inclination-adjusting mechanism

14 casing of sealing arrangement

15 inlet for hot air

16 distribution channels

17 heating cartridge

18 heating cartridge

19 overflow channels

20 overflow channels

21 outlet channel

22 outlet nozzles

23 temperature sensor

24 casing (for electrical equipment)

25 transport direction

I claim:

1. A process for producing a continuous tubular film from a flat film web and a heat sealing temperature which is shaped by a shaping arrangement into a tubular film having an overlapping portion, the tubular film being continuously supplied to a sealing arrangement which welds the overlapping portion of the film together, comprising welding of the overlapping portion of the film in the sealing arrangement by applying hot air to the overlapping portion of the film.

2. The process according to claim 1, wherein the hot air is heated compressed air and is applied to the tubular film via outlet nozzles.

3. The process according to one of claims 1 or 2, wherein the hot air is simultaneously directed towards a definite length of the tubular film by means of a plurality of outlet nozzles.

4. The process according to one of claims 1 to 3, wherein the temperature and/or the amount of hot air applied are/is regulated and capable of being adapted rapidly to the requisite conditions.

5. The process according to one of claims 1 to 4, wherein the temperature of the hot air is measured by a temperature sensor and the heat output of the heating arrangement is regulated in response to the temperature sensor measurement.

6. The process according to one of claims 1 to 5, characterized in that the temperature of the hot air is in the range from about 150 to about 190° C.

7. A device for producing a continuous tubular film from a flat film web, with a shaping arrangement for shaping the film into a tubular film having an overlapping portion, the tubular film being continuously supplied to a sealing arrangement for longitudinal welding of the overlapping portion of the film, comprising a sealing arrangement having one or more outlets adapted for applying hot air to a length of the overlapping portion of the film.

8. The device according to claim 7, wherein the sealing arrangement comprises a casing with at least one air inlet which branches into distribution channels which are connected via overflow channels to at least one heating arrangement which in turn are connected via overflow channels to an outlet channel.

9. The device according to one of claims 7 or 8, wherein the outlet channel extends over a length in the longitudinal direction of the tubular film and comprises a plurality of outlet nozzles which are directed toward the overlapping region of the edges of the film.

10. The device according to one of claims 7 to 9, wherein the sealing arrangement is arranged at a distance from the tubular film and does not touch the latter.

11. The device according to one of claims 7 to 10, wherein the heating arrangement comprises an electrically operated heating cartridge.

12. The device according to one of claims 7 to 11, wherein a temperature sensor is located in the outlet channel.
